(19) United States
(12) Patent Application Publication
(10) Pub. No.: US 2002/0103990 A1
(43) Pub. Date: Aug. 1, 2002

(54) Programmed load precession machine

(76) Inventor: Hanan Potash, Austin, TX (US)

Correspondence Address: Kevin L. Daffer, Conley, Rose & Tayon, P.C., P.O. Box 398, Austin, TX, 78767-0398, US

(21) Appl. No.: 09/776,084

(22) Filed: Feb. 1, 2001

(51) Int. Cl. G06F 9/30

(52) U.S. Cl. 712/215; 712/23

(57) ABSTRACT

An architecture and method are presented for a computer processor supporting interleaved execution of multiple concurrently-active threads, and capable of independently allocating a portion of the total processor execution time to each of the threads. Compared to existing architectures, in which the portion of processor time allocated to each thread is fixed, the processor architecture described herein is believed to offer higher performance for applications such as communications protocol processing, in which the workload of individual threads may vary, and in which the workload requires real time facilities.

### BACKGROUND OF THE INVENTION

1. Field of Invention

This invention relates to computer architecture, and more particularly, to a high-performance processor for high-speed multithreaded computing.

2. Description of Related Art

In the near future, digital communications networks are expected to undergo tremendous growth and development. As their use becomes more widespread, there is an attendant need for higher bandwidth. To fill this need, present-day copper wire-based systems will gradually be replaced by fiber optic networks. Two key factors enabling this trend will be inexpensive fiber optic links and high-speed distributed protocol processors. The latter are essential in preserving bandwidth while interfacing between dissimilar protocols, such as SONET, Ethernet, Fiber Channel and FireWire.

A protocol processor is a type of high-speed computer, optimized for fast context switching and a specialized communications-oriented instruction set. These features allow the protocol processor to operate efficiently within a network containing other similar processors implementing various communications protocols.

Because of the fast execution speed of modem processors, a multitasking computer gives the appearance of running several tasks concurrently. However, since most processors can only do one thing at a time, the tasks do not actually execute simultaneously. Instead, each task receives the processor's attention periodically during an interval called a “time-slice”. Between time-slices, the processor must change context. The context typically comprises current register contents, program counter, status, etc. associated with the task, which must be saved before the task is suspended, and restored before it can resume execution. Often, in a conventional computer, the context is saved to and restored from system memory. However, since system memory access is generally slower than the processor execution speed, context switching can consume several processor clock cycles.

Part of the overhead associated with context switching is due to the isolation between individual tasks imposed by the operating system that manages the tasks. In order to preserve system integrity, the operating system allocates resources, such as memory space, files, etc., to each task. During execution, a task is allowed access only to its own resources. This provides a measure of protection against tasks interfering with one another, but unfortunately, complicates context switching. Furthermore, a task may slow the overall operation of the system by its inefficient use of system resources. Suppose, for example, that the system printer is dedicated to a specific task. Since the printer is typically much slower than the processor, the task may spend the majority of its time waiting for the printer. Consequently, during that task's time-slice, the processor may be completely idle, yet unavailable for other tasks.

For many applications, multithreading is an efficient alternative to multitasking. A thread, sometimes called a lightweight process, may be defined as the basic unit of processor utilization. Compared to a task, a thread requires a minimum of system resources; a program counter, a register set and/or stack space. In contrast to a task, it shares code, data, and various operating system resources, such as open files, with peer threads. This greatly simplifies context switching. A task may be comprised of multiple threads, and because the threads share system resources, they may execute concurrently during the task's time-slice. This allows more efficient utilization of the processor. Returning to the previous example, if one of the threads in a multithreaded task has to wait for the printer, the task's other threads can continue to execute.

The architecture of a computer can be optimized for multithreading. There are two major approaches to the design of multithreaded computers: “programmable multithread” and “precession machine” (also known as “commutator”). In a programmable multithread machine, context switching is done via thread switch CALL instructions in software (hence, the context switch is “programmable”). Whereas, in a standard processor, the context is typically stored to and retrieved from system memory, a programmable multithread machine employs dedicated register banks to accomplish the context switch more quickly. An example of the use of dedicated register banks for context switching is the SPARC processor, which employs a “moving window” consisting of 32 registers. When a context switch occurs, the window slides up or down 8 registers, resulting in a new context that preserves 24 of the previous registers along with 8 new ones. An advantage of the programmable multithread machine is that it can be readily implemented using one or more conventional processors. However, the use of multi-processor systems brings with it the potential for “aliasing”. This is a problem that can occur when multiple processors share a memory resource, such as a data cache. Suppose, for example, that processor “A” temporarily stores a value in a shared cache location, creating an alias to the original memory location. Further suppose that, based on some computation, processor “A” updates the value in the cache then, several cycles later, updates the original memory location. Now, if processor “B” reads the value from memory after it has been put in cache but before the update, it will read the wrong alias value. Clearly, if the value is something like an address pointer, serious problems can result. Of course, measures can be taken to prevent aliasing, but such protection generally adds overhead to the system.

In the precession machine approach to multithreaded processing, all the currently executing threads may be active simultaneously. The processor services the threads in a prescribed sequence, with each thread being allotted a fixed time-slice (typically one cycle, or the time it takes to initiate a single instruction). For any given thread, the interval between time-slices (referred to herein as the “precession cycle time”) is simply the sum of the time-slices of all the threads. (In existing precession machines, all the threads may be always active.) Advantageously, the precession cycle time is consistent and predictable. Each thread has a dedicated set of registers, within which its context is preserved. Since there is no need to swap these data to memory, context switching can be very fast.

In present precession machine architectures, the sequence in which threads are serviced by the processor and the time-slice devoted to each thread are determined by the hardware configuration of the particular machine, and cannot be modified in software. The precession machine architecture has three principal advantages compared to the programmable-multithread architecture: interleaved operation, a simplified memory interface, and real time capability. Interleaved operation refers to the use of multiple banks of memory that are accessed in sequence by the active threads. Using interleaved operation, the throughput of the computer is limited by the processor speed, rather than the (generally slower) access time of the memory. A simplified memory interface is another advantage of the precession machine architecture. Since the time for a memory access is masked by the time slots taken by the other threads, a data cache is not required in a precession machine multithread computer. This obviates the problems associated with aliasing described earlier, and eliminates the need for complex arbitration logic ordinarily required to maintain cache coherency. Another basic problem with cache machines that is eliminated is “thrashing.” Caches are filled in block transfers of typically four to sixteen neighboring words at a time, which slows down the machine considerably if the data are sparse and the neighbors are not used. The precession machine architecture is also very well suited for real time applications, since thread timing is inherently predictable.

In present-day multithreaded applications, such as communications processing, the workload of each thread can vary considerably. For example, while one thread may be devoted to polling a slow peripheral device, another may be responsible for performing highly computation-intensive calculations. In the most straightforward implementation of the precession machine, the time-slice allocated to each thread is fixed. This is a significant drawback in situations such as communications protocol processing, which involve multiple processes having dissimilar workloads. If the actual thread workload is variable, a fixed time-slice allocation will inevitably result in inefficiency.

### SUMMARY OF THE INVENTION

The problems outlined above are in large part solved by a computer processor architecture supporting interleaved execution of multiple concurrently-active threads, and capable of independently allocating a portion of the total processor execution time to each of the threads during runtime.

In a preferred embodiment, the processor comprises a cycle allocation table, containing thread identifiers for the active threads, and a commutator. Using a circular counter, the commutator repeatedly runs through the cycle allocation table, executing threads in the order in which their identifiers appear in the table. A context, comprising a program counter and register set, is associated with each active thread; each thread executes within its own context. The processor devotes one clock cycle to each table entry (i.e., each clock cycle allows the initiation of one instruction, or one instruction set in a multiple instruction issue per cycle machine, in the thread). Throughout the remainder of this discussion, the term “instruction” will refer to the instruction or instruction group the processor may issue per cycle. Once initiated, the instruction(s) will proceed to completion by progressing through the machine's pipeline. Therefore, the processor execution time allotted to a thread is based on the number of times its identifier appears in the cycle allocation table. Since the table may be software-configurable, it may be modified during runtime. This allows the processor to adapt to varying thread workloads by allotting more processor time to busier threads.

In an embodiment, the processor further comprises pipeline control and memory transaction logic, which ensure that results of a memory transaction or pipeline operation are directed to the register set of the thread that issued the transaction or operation, rather than to the currently-executing thread. Pipeline/register interlock logic is also provided, to prevent access to a register awaiting a result from a pending transaction until the result is returned. Bypass logic may also be included, which stores the result in a register and simultaneously feeds it to the awaiting pipe stage logic. In a preferred embodiment, there are up to 16 active threads and 64 entries in the cycle allocation table, and each register set comprises 32 registers.

A method for interleaved execution of multiple threads by a computer processor is also contemplated herein. The method consists of assigning each thread an identifier and an execution context, the latter consisting of a program counter and register set. The method further includes independently allocating a portion of the total processor execution time to each thread, and executing each thread for its allotted time. Best results are achieved when the thread's allotted time is evenly spread throughout the 64 cycles. Thus, a thread receiving ¼^{th} of the machine's processing power will be allotted every fourth cycle—e.g., cycles 3, 7, 11, 15, etc. According to the method, execution time is allocated to a thread by placing its identifier in a cycle allocation table. Threads are executed in the order in which their identifier appears in the table, and the number of instruction(s) initiation clock cycles allotted to a thread is based on the number of times its identifier appears in the table. Advantageously, the method allows modification of the table during runtime. This allows the processor to reapportion the execution time so that the busiest threads receive the most clock cycles. The reapportionment can be done by a privileged instruction whose programmed parameter is the new allocation table.

The architecture and method described herein are believed to offer improved performance over existing multithreaded and multithreaded precession processors in applications in which the threads have a variable workload.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF THE DRAWINGS

Other objects and advantages of the invention will become apparent upon reading the following detailed description and upon reference to the accompanying drawings in which:

Figs. 1a and 1b depict pipeline utilization in a benchmark test run on a single-threaded processor, and a single-threaded processor with data cache;

FIG. 2 illustrates the “commutator” analogy to the operation of a precession machine-type multithreaded processor;

FIGS. 3a and 3b depict pipeline utilization in a benchmark test run on a four-threaded processor, and a four-threaded processor with banked memory;

FIG. 4 contains a block diagram of an embodiment of the multi-threaded processor architecture and method described herein;

FIG. 5 describes the operation of the processor cycle allocation according to the architecture and method described herein, wherein each thread is allocated the same number of cycles; and

FIG. 6 describes the operation of the processor cycle allocation according to the architecture and method described herein, wherein some threads are allocated a different number of cycles.

### DETAILED DESCRIPTION OF THE PREFERRED EMBODIMENTS

For many high-speed computing applications, such as communications protocol processing, multithreading is an efficient alternative to multitasking. A conventional process (i.e., a task) has a single flow of control, comprising a sequence of instructions executed by the process. In a multithreaded process, there are multiple scheduled flows of control called “threads.” By splitting the work done by the process into smaller pieces, individual threads can pursue each piece concurrently. Every thread has its own program counter, register set and stack space. However, unlike a task, a thread shares its code space, data space, and various operating system resources, such as open files, with peer threads. Hence, context switching between threads is considerably less complicated than for tasks, since no memory management is involved.

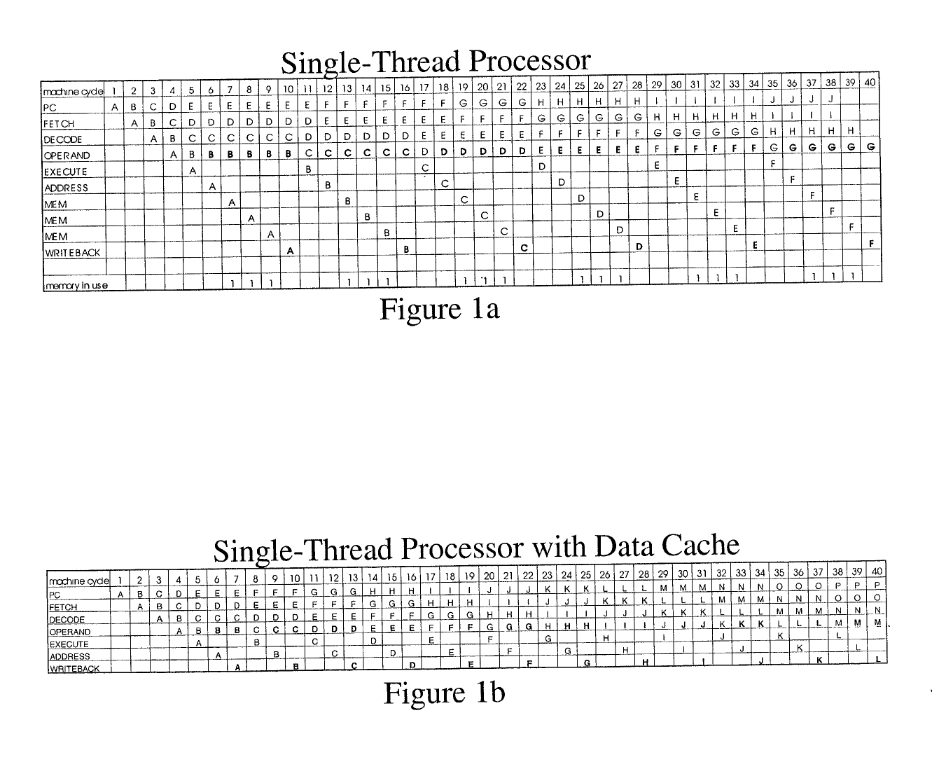

In a standard multithreaded computer, memory latency limits the speed at which instructions may be completed, since memory instructions cannot complete until data is back from memory, enabling the processing of the next instruction in the thread. No matter how fast the processor, overall throughput cannot exceed the speed with which the memory can be accessed. FIG. 1a illustrates the operation of a single-thread processor executing a long read indirect instruction sequence. This type of instruction sequence is an appropriate benchmark for the IP address table lookup of communications applications. The form of the instruction in this loop is:

### Read R7, R7, Displacement

The effect of this instruction is to read a location in memory pointed to by register R7, and then place the contents of that location back into R7, so it points to the next location to be read. In this example, the processor is assumed to have a multi-stage pipeline, a set of local registers and main memory with a latency of three clock cycles. Execution of an instruction requires a sequence of constituent operations to be performed on the instruction and its operands in the successive stages of the pipeline. In the example of

FIG. 1a, the operations performed in each pipeline stage are:

Stage 1: Program Counter Increment

Stage 2: Fetch Instruction from Instruction Cache

Stage 3: Instruction and Register Address Decode

Stage 4: Fetch Operands from Register File

Stage 5: Perform Addition

Stage 6: Send Address to Memory

Stage 7: Read

Stage 8: Read

Stage 9: Read

Stage 10: Return Operand from Memory and Store in Register

Note that three pipeline stage delays are devoted to reading from main memory, because of the three cycle latency. Optimally, each of the pipeline operations is accomplished in one processor clock cycle. However, if any stage of the pipeline is unable to complete its operation in a single clock cycle, all the preceding stages must be made to wait. This is known as “stalling” the pipeline.

The top-most row in the table of FIG. 1a shows consecutive processor clock cycles, while the next 10 rows indicate the progress of instructions A, B, D, etc. through the stages of the pipeline. Instruction A enters the first pipeline stage (i.e., Program Counter Increment) during clock cycle 1. In clock cycle 2, instruction A passes to the second pipeline stage (Fetch Instruction from Instruction Cache), while instruction B enters the pipeline. By the 10^{th} clock cycle, instruction A has propagated to the 10^{th} stage of the pipeline. Were this process to continue for every instruction, the pipeline would be optimally utilized and the processor would execute instructions at a rate of one instruction per clock cycle. However, for instruction B, the pipeline stalls at clock cycle 6, encountering a delay of five cycles (stalled instructions are indicated with the number repeating horizontally across subsequent clock cycles). This delay is due to the fact that execution of instruction B requires the result of instruction A, which isn't available yet. Consequently, execution of instruction B is suspended for two clock cycles while instruction A moves through the EXECUTE and ADDRESS pipeline stages, and then for three additional clock cycles due to memory latency. Instruction B finally enters the EXECUTE stage of the pipeline in clock cycle 11. This pattern continues with subsequent instructions, resulting in an effective throughput of one instruction per six clock cycles.

A data cache can provide a dramatic improvement in average throughput, provided its side effects, aliasing, thrashing, and non-deterministic real time operation do not cause problems. Cache is generally much faster than main memory, and is effective whenever the majority of read/write activity is concentrated in a particular region of memory. The region of interest is first copied in a single block transfer to cache. The processor then performs high-speed read/write accesses to the cache. The use of a data cache improves throughput and allows the pipeline to be more efficiently utilized. This is illustrated in FIG. 1b. FIG. 1b reflects the assumption that all reads and writes are to cache, and therefore lacks the three “MEM READ” pipeline stages of FIG. 1a, which were necessitated by the latency of the main memory. Instruction A propagates through the pipeline in seven clock cycles, while instruction B is delayed at cycle 6 until A has completed execution two cycles later. Operation after this point continues in the same manner, resulting in a throughput of one instruction per three clock cycles.

In practice, a data cache may not actually double processor throughput, as the example of FIG. 1b might suggest. The efficacy of a data cache depends entirely on the processor's read/write activity being confined to a localized region of memory—one small enough to be transferred to the cache, and to the data in the cache being used repeatedly. This is often referred to as the “high data locality” of the task. Unfortunately, many applications, such as communications protocol processing, exhibit very poor data locality. In communications, by definition, the data is in transit. In such “poor data locality” cases, a data cache may not improve processor performance much at all. In fact, thrashing may actually slow down a processor to well below the speed of a similar processor without the cache.

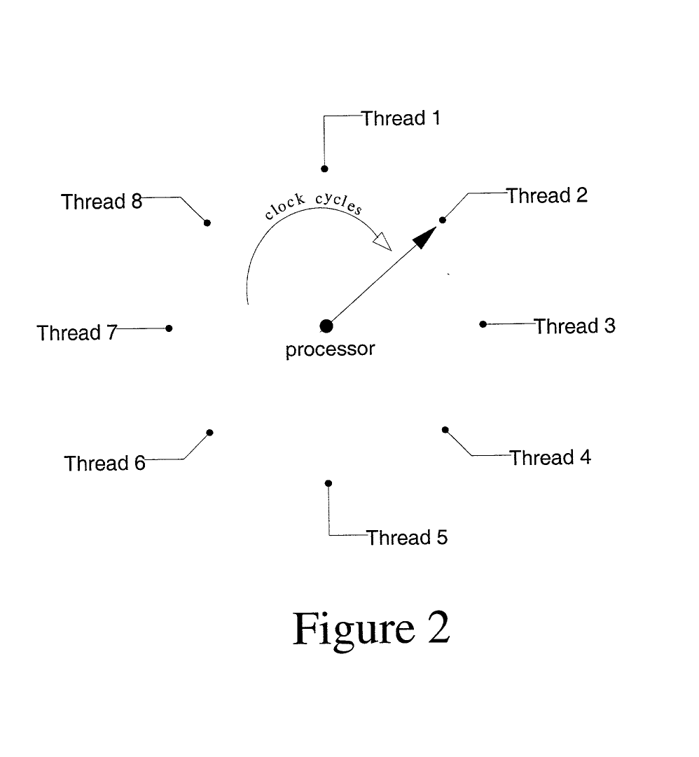

In a precession machine-type multithread computer, interleaved operation overcomes memory latency. FIG. 2 represents the action of the processor in a precession machine sequentially servicing eight active threads. The analogy to the distributor in an automobile engine is obvious, and explains why the precession machine is often referred to as a “commutator” architecture. Thread 2 is shown as the active thread. This means that the processor will devote one clock cycle to initiating one instruction (or instruction set, in a multiple instruction issue per cycle machine) in thread 2, before moving to thread 3. An active thread operates within its own execution context, comprising a dedicated program counter, register set, status, etc. As the commutator moves from one thread to the next, it performs a context switch. However, since context is preserved in any multithreaded precession machine, a context switch is accomplished without saving/restoring the present context to/from memory. This avoids the entire time overhead associated with context switching in a conventional processor. In FIG. 2, after the processor has serviced each of the threads for its allotted time-slice, it returns to thread 2. The interval required for the processor to complete its cycle (i.e., service all of the threads) is the precession cycle time.

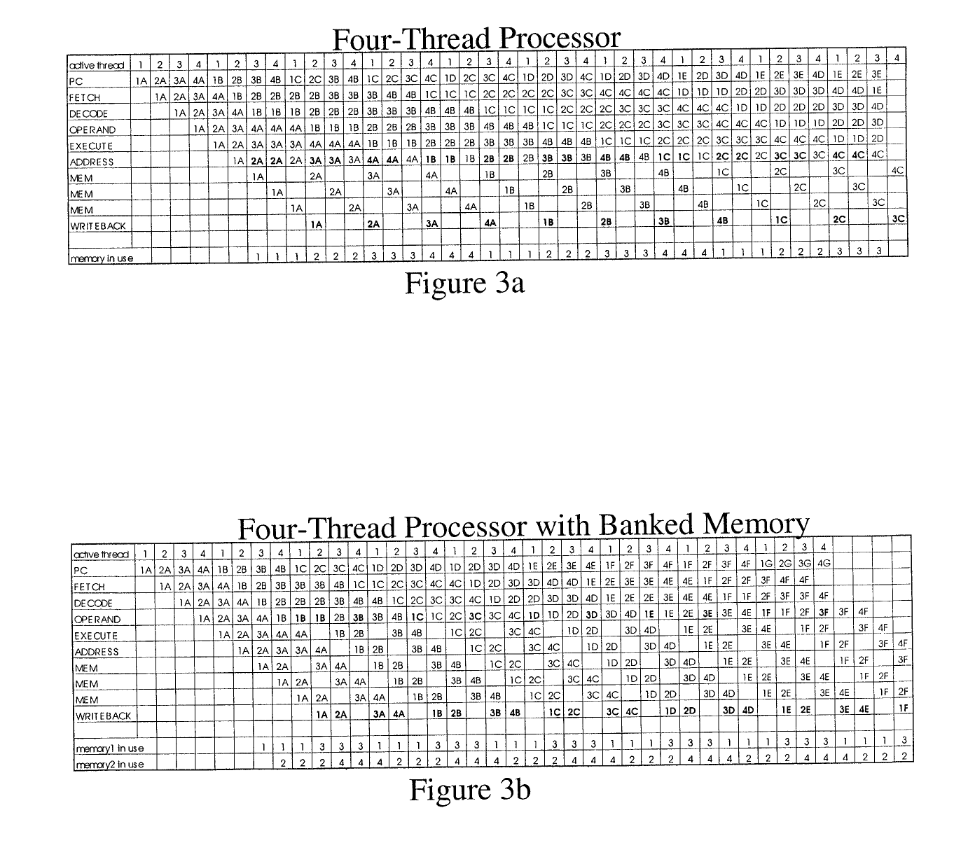

FIG. 3a presents an analysis similar to that of FIGS. 1a, b, for a precession machine having four threads. Each thread has a time-slice of one clock cycle, the memory latency is assumed to be 3 clock cycles, and there is no data cache. Instructions associated with each of the four threads are shown propagating downward through the ten-stage pipeline. For example, instruction 1A (i.e., the first instruction in thread 1) enters the first stage of the pipeline in the first clock cycle. In the next clock cycle, instruction 2A enters the first stage of the pipeline, while instruction 1A moves to the second stage. The pipeline stalls in clock cycle 7, when instruction 1A encounters the three-cycle memory latency. However, in contrast to the single-threaded case of FIG. 1a, there is no additional delay while the processor waits for the result of the previous instruction. This is a direct advantage of the precession machine architecture. In a conventional single-threaded computer, the indirect read instruction sequence must update a shared register, R7. Therefore, it is always necessary for the previous instruction in the pipeline to complete before the next instruction can continue execution. In the precession machine however, each thread has its own register set. Furthermore, each instruction in a thread uses as an operand the result of the previous instruction in the same thread. For example, instruction 2C uses the result of instruction 2B. Because of the interleaved processing of the threads, the instructions in consecutive stages of the pipeline belong to different threads. This avoids the dependence of an instruction in any stage of the pipeline on a result generated by the instruction in the following stage. This explains why the pipeline in FIG. 1a first stalls when a new content for R7 is needed by instruction B to compute the memory address (clock cycle 6), because instruction A has not yet relinquished R7 since R7 is content interlocked. In comparison, the pipeline of FIG. 3a does not stall at this point, since by the time R7 is used by the thread its content is good. Thus, memory latency alone limits the throughput of the multithreaded processor of FIG. 3a to one instruction per three clock cycles. Although this appears equivalent to the performance of the single-threaded processor with cache (FIG. 1b), it is actually a good deal better, since there is no presumption of data locality.

A further improvement in throughput is readily obtainable with a precession machine, through the use of banked memory. Banked memory is a technique for effectively increasing memory throughput by alternating memory accesses between different banks. For instance, assume that the main memory in a computer has an access time of 40 ns, but that the processor in the computer has a 20 ns clock cycle. If the memory were configured as a single continuous address space, each memory access would require two clock cycles. During procedures involving extensive memory access, the processor could effectively be slowed to half its true operating speed. To avoid this, the memory may be organized as two or more separate banks, such that consecutive memory accesses alternate and overlap between the two banks. The contemplated product will have four memory banks. When the processor executes an instruction involving a memory access to one bank, instead of waiting 20 ns, it proceeds to the next instruction, which comes from a different thread. If that instruction is also a memory access, it is likely to go to a different bank. In the following clock cycle, the first memory access can be completed. By alternating memory accesses in this fashion, the processor can operate at full speed, without being impeded by the slower memory.

The precession machine architecture is well suited to the use of banked memory. If each of the memory banks is associated with one or more of the active threads, interleaved memory access occurs as the processor sequentially executes the threads. An example of the use of banked memory by a precession machine, and the resulting improvement in throughput, is presented in FIG. 3b. In this example, there are two memory banks used with the same four-threaded precession machine discussed earlier in connection with FIG. 3a. Memory bank 1 is associated with threads 1 and 3, and memory bank 2 with threads 2 and 4. Both memory banks are assumed to have the same three-cycle latency as before. Referring to the table in FIG. 3b and following the progress of instruction 1A (i.e., instruction A of thread 1) through the pipeline, note that the first memory read occurs in clock cycle 7. Corresponding to this operation, the next to last row of the table shows that memory bank 1 is in use. While instruction 1A waits for the memory read to complete, during clock cycles 8 and 9, memory bank 1 is inaccessible. However, memory bank 2 is available to thread 2. Consequently, instruction 2A is not stalled in the pipeline and proceeds to the memory read operation. Corresponding to these stages, the bottom row of the table in FIG. 3b shows that memory bank 2 is in use. Since threads 1 and 3 share memory bank 1, the first pipeline stall occurs in stage 8, where instruction 3A must wait two clock cycles for the completion of the read operation being performed by instruction 1A. The average throughput of the four-threaded precession machine with two banks of memory is two instructions per three clock cycles. This exceeds the performance of the single-threaded machine with a data cache. With four memory banks, throughput could be increased to one instruction (or instruction issue set) per clock cycle—the limiting factor then being the speed of the processor itself.

Thus, the precession machine offers potentially higher performance than a conventional single-threaded processor, or standard multithreaded processors that operate on one thread at a time. In the standard multithreaded machine the context switch is fast, but the machine still suffers the pipeline limitation of a single-threaded machine. However, the fixed allocation precession machine suffers from a significant practical limitation in that the allocation of processor time (also described as “processor bandwidth”) to each thread is fixed at 1/n of the machine's throughput (where n is the number of threads) and cannot be modified. This limitation is important in applications such as communications protocol processing, in which the threads may have disparate and variable workloads. In this type of application, it is impossible to achieve maximum efficiency from the precession machine without some means of adaptively allocating processor bandwidth.

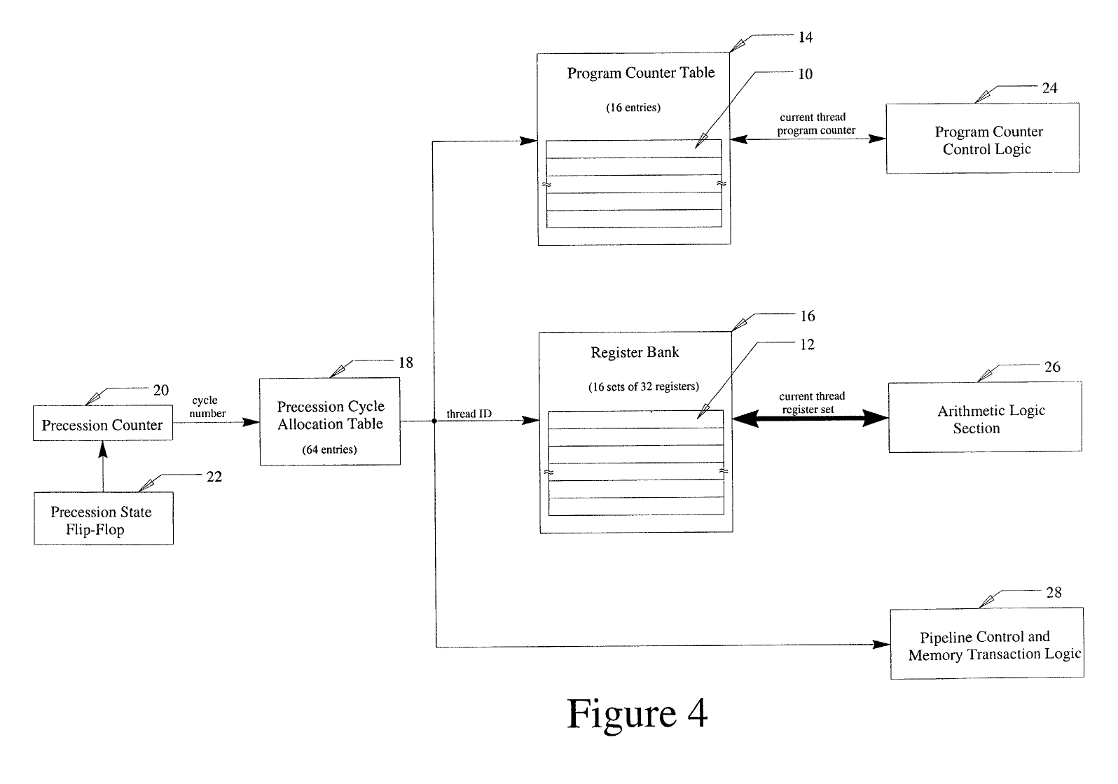

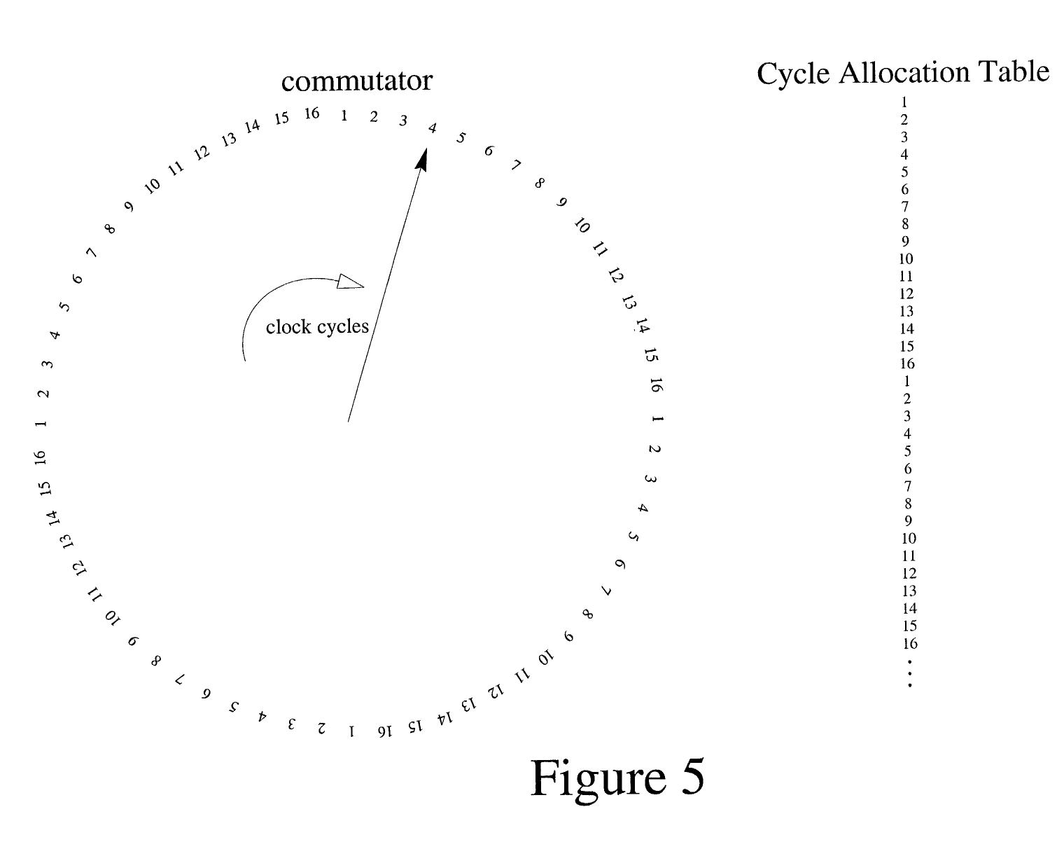

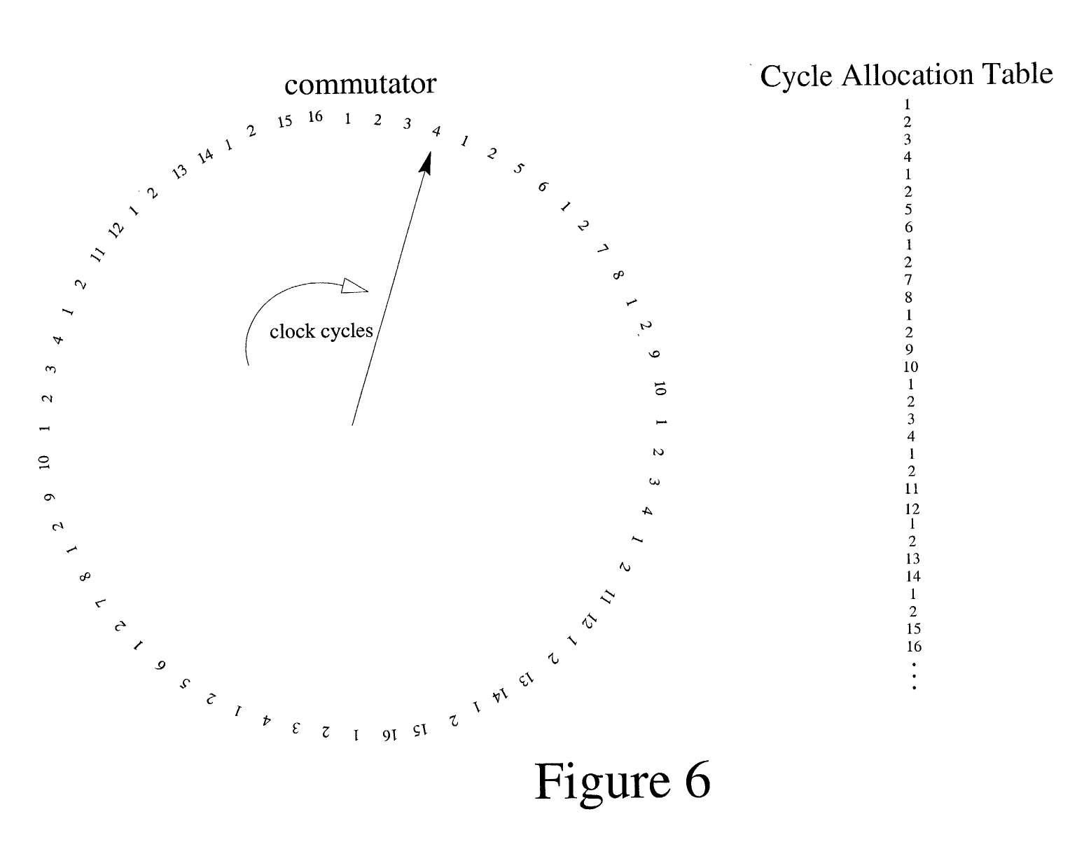

The architecture and method described herein address this limitation of the conventional precession machine by providing a means of reallocating processor bandwidth. A preferred embodiment of this configurable precession machine is shown in FIG. 4. The embodiment of FIG. 4 is a 64-state precession machine, containing 16 threads. Each thread has its own execution context, comprising a program counter 10 and a set 12 of 32 registers. Each program counter is an entry in Program Counter Table 14. Similarly, each set of 32 registers is an entry in Register Bank 16. Associated with each entry in Table 14 and Bank 16 is a thread identifier, denoting the particular thread that owns that program counter and register set. The Precession Cycle Allocation Table 18 determines the portion of total processor execution time devoted to each active thread. There are 64 entries in this table, corresponding to the 64 possible processor states, and each entry in the table is a 4-bit thread identifier. A circular (i.e., modulo 64) counter 20 repeatedly sequences through the Cycle Allocation Table at a rate of one entry per clock cycle. As it does so, the processor executes the thread whose identifier is contained in the current table entry. Therefore, the number of table entries containing a given thread identifier represents the number of clock cycles devoted by the processor to that thread's instruction initiation over the precession cycle time (in this case, 64 clock cycles). If a particular thread has a greater workload, that thread can be given more of the processor bandwidth (i.e., clock cycles) simply by writing its identifier to more locations in the Cycle Allocation Table. Doing so, of course, “steals” bandwidth from the other threads, but this may be acceptable when the other threads have a lighter workload. To preserve the advantages of the precession machine architecture discussed in connection with FIG. 3b, it is desirable to distribute the thread identifiers in the Cycle Allocation Table so as to preserve interleaved operation. This is illustrated by a pair of examples in FIGS. 5 and 6. Using the commutator analogy, FIG. 5 shows the sequence of execution of the 16 threads over one precession cycle (i.e., 64 clock cycles). In this case, the threads each receive 4 clock cycles, but their execution is interleaved to overcome memory and pipeline latency. Thus, each thread executes for 1 clock cycle out of every 16 clock cycles. A portion of the Cycle Allocation Table corresponding to the thread execution sequence is shown on the right in FIG. 5. As described above, the 64 entries of this table are the 16 thread identifiers, arranged in the order in which they will be executed by the processor.

The number of times a thread identifier appears in the Cycle Allocation Table represents the number of clock cycles it will receive in each precession cycle. By changing the number of occurrences of the thread identifier, it is possible to change the amount of processing time (i.e., processor bandwidth) allocated to the corresponding thread. In the example of FIG. 5, each thread was allocated the same processor bandwidth. This would be appropriate for an application in which the threads have similar workloads. However, in many applications not only do the threads have dissimilar workloads, but the workload of any given thread may vary with time. For example, a thread may have a heavy workload at one point in time and later become idle. The architecture and method described herein permit more efficient use of the processor in such cases, by allocating the most processing time to the busiest threads.

FIG. 6 illustrates the thread execution sequence and Cycle Allocation Table for a situation in which threads 1 and 2 have each been allocated 16 clock cycles, and threads 3 and 4 have allocated 4 clock cycles out of every precession cycle. The remaining 24 clock cycles are equally distributed among the other 12 threads, so that each of them receives 2 clock cycles. As in the previous example, thread execution is interleaved. Thus, threads 1 and 2 execute every 4^{th} clock cycle, threads 3 and 4 every 16^{th} clock cycle, and threads 5-16 every 32^{nd} clock cycle. This allocation of processor bandwidth corresponds to threads 1-4 having a heavier workload, and therefore requiring a greater share of processor time. Since the Cycle Allocation Table (shown on the right in FIG. 6) may be software-configurable, bandwidth allocation can be modified during runtime. This allows the precession machine to adapt to a varying workload among the threads. The capability of adaptively allocating processor bandwidth according to the workload of the threads is believed to be an important advantage, since it allows more efficient use of the processor in a variable workload situation. Although the preceding example uses threads 1-4 to illustrate this capability, it should be clear that other numbers and choices of threads, and allotments of processor time could easily have been used.

Communications processing is composed of parallel “real time” applications. In a real time application, the machine time lapse for a given program segment must be predictable (or deterministic). By allocating threads of fixed bandwidth, all operating directly from memory, without the unpredictability of the cache, the threads form a well behaved, easy to manage, real time environment.

Referring again to the embodiment of the present architecture and method shown in FIG. 4, Precession State Flip-Flop 22 selects between single-threaded and multithreaded operating modes. When the processor is first powered up, this flip-flop is in the “0” state, disabling Precession Counter 20, and forcing every processor clock cycle to be devoted to thread 1. Once the processor is properly initialized, a special instruction resets flip-flop 22, enabling counter 20 and allowing multithreaded operation. The Program Counter Table 14 interfaces to the processor's Program Counter Control Logic 24, so the program location of the currently-executing thread is properly updated. Similarly, Register Bank 16 interfaces to Arithmetic Logic Section 26, so that computations are performed within the execution context of the currently-executing thread. The current thread identifier is also passed along to Pipeline Control and Memory Logic 28. This is done so that memory operands and the results of pipelined operations are posted in the register bank of the proper thread. Because of the interleaved execution of the threads, data from memory transactions and pipeline operations will generally not appear while the thread that issued the transaction or operation is active. For example, due to latency, the contents of a memory location will not appear on the data bus for at least three clock cycles after the read operation is initiated. At that point, the processor will typically have switched context to service another thread. It is the responsibility of the Pipeline Control and Memory Transaction Logic 28 to ensure that when such results become available they are placed in the register set of the thread that initiated the transaction or operation.

Note that the need for a system of result posting is not restricted to multithread computers. For example, consider the case of a standard single-threaded processor, operating with a DMA controller and dual-bank memory. Now suppose that two consecutive memory read instructions are executed; the first places a result into register R3 and the second into register R5. Further suppose that a DMA access to the first memory bank delays the result for the first instruction, so the result from the second instruction arrives first. Although the order of arrival of the results is the opposite of the instruction sequence, the memory control logic must correctly associate each result with the proper register. One means of ensuring this is to send the register physical number along with the request. The physical number contains both the thread number and the number of the register within the thread's register set.

In a multithreaded machine, the register number alone would be ambiguous, since each thread has a complement of registers R0-R31. Therefore, in an embodiment of the present architecture and method a two-tuple, consisting of both the thread identifier and the register number is sent. To avoid late-aliasing, which could arise when two sequential instructions access the same register, a register for which a result is pending is flagged by the pipeline/register interlock logic as “empty.” When the currently-executing thread initiates a transaction involving a result register the empty flag for that register is set; the empty flag is cleared when the awaited result is actually posted in the register. If a thread attempts to access an “empty” register, it is forced to wait until the pending result arrives and the empty flag is cleared.

The present architecture and method combine the inherent advantages of the precession machine—the ability to provide a deterministic real time environment and the capability to adaptively allocate processor bandwidth to the active threads. This is believed to be an improvement over existing multithreaded processor architectures for applications such as communications protocol processing, which require the simultaneous, real time operation of parallel threads and where the workload of threads can vary. By allocating more computing bandwidth to the busiest threads, the processor works more efficiently in these applications than does a conventional fixed time-slice precession machine.

It will be appreciated by those skilled in the art having the benefit of this disclosure that this invention is believed to present an architecture and method for real time synchronized parallel processing and runtime or static-configurable allocation of processor execution time to threads in a multithreaded computer. The synchronized nature of multiple precession threads is such that they always keep the same relative timing location, and cannot fall out of step with each other as can parallel processors, or standard multithread programs that rely on a supervising program to allocate the thread's run time segment. Further modifications and alternative embodiments of various aspects of the invention will be apparent to those skilled in the art in view of this description. Such details as the number of threads and registers, and the number of clock cycles in the precession cycle as described herein are exemplary of a particular embodiment, and may be altered in other embodiments. It is intended that the following claims be interpreted to embrace all such modifications and changes and, accordingly, the specification and drawings are to be regarded in an illustrative rather than a restrictive sense.

What is claimed is:

1. A computer architecture supporting interleaved execution of multiple threads, comprising:
a processor adapted to initiate instructions associated with a thread;
a commutator adapted to sequentially select threads for instruction initiation by the processor; and
a cycle allocation table operably coupled to the commutator, comprising an execution time individually allotted to each of the threads.

2. The computer architecture as recited in claim 1, wherein said allotted execution times are not the same for all the threads.

3. The computer architecture as recited in claim 1, wherein the cycle allocation table is capable of being reconfigured during runtime, allowing the execution time allotted to the threads to be independently modified.

4. The computer architecture as recited in claim 1, wherein the configuration of the cycle allocation table and the execution time allotted to the threads is fixed and determined when the processor is designed or manufactured, and cannot be modified during runtime.

5. The computer architecture as recited in claim 1, wherein the commutator comprises a circular (i.e., modulo N) counter generating addresses in the cycle allocation table.

6. The computer architecture as recited in claim 1, further comprising a thread identifier and an execution context associated with each thread, wherein the execution context comprises a program counter and register set.

7. The computer architecture as recited in claim 1, wherein the processor execution time represents a number of clock cycles.

8. The computer architecture as recited in claim 1, wherein the cycle allocation table contains thread identifiers and the processor execution time allotted to a thread is based on the number of occurrences of its thread identifier in the cycle allocation table.

9. The computer architecture as recited in claim 1, wherein the processor execution time allocated to a given thread is commensurate with the workload of the thread.

10. The computer architecture as recited in claim 6, further comprising pipeline control and memory transaction logic, wherein said logic ensures that results of a pipeline operation or memory transaction are directed to the register set belonging to the thread that issued the operation or transaction.

11. The computer architecture as recited in claim 6, further comprising pipeline/register interlock logic adapted to prevent access to a register awaiting a result from a pending transaction until the result is returned.

12. The computer architecture as recited in claim 8, wherein the processor may initiate from 0 to N instructions each clock cycle, where N≧1.

13. The computer architecture as recited in claim 8, wherein the processor has no instruction pipeline, and initiates one instruction per clock cycle.

14. The computer architecture as recited in claim 6, wherein there are 16reads, wherein each register set comprises 32 registers, and wherein the cycle allocation table comprises 64 entries.

15. A method for interleaved execution of a plurality of threads by a computer processor, comprising:
assigning each thread a program counter, register set and thread identifier;
allotting a portion of an execution time of the processor to each thread, wherein a size of the portion may be different for each thread, and wherein the size of each portion comprises an allocation of the execution time; and
executing simultaneously the plurality of threads, with each thread executing for its allotted instruction initiation time.

16. The method as recited in claim 15, wherein said allotting a portion of an execution time comprises placing one or more occurrences of the thread identifier in a cycle allocation table.

17. The method as recited in claim 16, wherein threads are executed in the order in which their thread identifiers appear in the cycle allocation table.

18. The method as recited in claim 16, wherein the portion of the execution time allotted to a thread is based on the number of occurrences of its thread identifier in the cycle allocation table.

19. The method as recited in claim 15, wherein the allotted execution time for a given thread is commensurate with the workload of the thread.

20. The method as recited in claim 15, wherein the allotted execution time for a given thread is commensurate with the real time requirement of the program to which the thread belongs.

21. The method as recited in claim 15, wherein the allotment of execution times to threads may be reapportioned during runtime.

22. The method as recited in claim 15, wherein the result of an operation performed by the computer processor is directed to the register set belonging to the thread that issued the operation or transaction, regardless of which thread is executing when the result becomes available.

23. The method as recited in claim 15, wherein access to a register awaiting a result from a pending transaction is prevented until the result is returned.
